(19) United States
(12) Patent Application Publication
(10) Pub. No.: US 2025/0240118 A1
(43) Pub. Date: Jul. 24, 2025

(54) ENCODING AND DECODING DATA

(71) Applicant: Telefonaktiebolaget LM Ericsson (publ), Stockholm (SE)

(72) Inventors: Leif WILHELMSSON, Lund (SE); Rocco DI TARANTO, Lund (SE); Abhishek AMBEDE, Huddinge (SE)

(21) Appl. No.: 18/699,748

(22) PCT Filed: Oct. 12, 2021
(86) PCT No.: PCT/EP2021/078197

§ 371 Date: Apr. 9, 2024

(51) Int. Cl. H04L 1/00; H04B 1/715; H04B 17/309

(52) U.S. Cl. CPC H04L 1/0041; H04B 1/715; H04B 17/309

(57) ABSTRACT

Methods and apparatus are provided. In an example aspect, a method in a first wireless communication device of encoding data for transmission to a second wireless communication device using a first signal in a first frequency range having a first bandwidth is provided. The method comprises includes determining a second bandwidth based on at least one interference signal within the first frequency range, wherein the second bandwidth is smaller than the first bandwidth, selecting a code rate based on the second bandwidth such that the data is recoverable from a portion of the first signal having a bandwidth equal to or less than the first bandwidth minus the second bandwidth, and encoding the data using the code rate to produce encoded data bits.

TECHNICAL FIELD

Examples of the present disclosure relate to encoding data for transmission or to decoding data.

### BACKGROUND

When undertaking wireless communication in unlicensed bands, such as for example the 2.4 GHz Industrial, Scientific and Medical (ISM) band and the 5 GHz band, some means of spectrum sharing mechanism is typically required unless the transmissions are limited to use a very low power. The two most commonly used spectrum sharing mechanisms are listen before talk (LBT), also referred to as carrier sense multiple access with collision avoidance (CSMA/CA), and frequency hopping (FH).

The working procedure of LBT is as follows. Before a transmission can be initiated, the transmitter listens on the channel to determine whether it is idle or if there is already another transmission ongoing. If the channel is found to be idle, the transmission can be initiated, whereas if the channel is found to be busy, the transmitter must defer from transmission and essentially keep sensing the channel until it becomes idle. LBT is used by different flavors of IEEE 802.11, commonly referred to as Wi-Fi, operating in the 2.4 GHz ISM and 5 GHz bands. LBT is also employed by standards developed by 3GPP operating in the 5 GHz band, e.g. New Radio-Unlicensed (NR-U). If FH is used instead, the spectrum sharing is based on only using a specific part of the band for a relatively small fraction of the total time, leaving room for other transmissions. FH is the approach used by Bluetooth.

Whether to employ LBT or FH is not clear, but typically LBT is the preferred approach if the used channel bandwidth is relatively large, say 20 MHz or more. FH, on the other hand, is well suited for narrowband systems where the bandwidth is of the order of 1 or 2 MHz. To a large extent this explains why Wi-Fi uses LBT whereas Bluetooth uses FH. The primary goal for Wi-Fi is to provide high data rates, with use cases like file download and file streaming. Bluetooth, on the other hand, is more concerned with voice and other delay sensitive applications like connecting computer peripherals.

When narrowband transmissions are made without using LBT, such as for example if FH is used, there may be a wideband transmission (e.g. Wi-Fi) already ongoing and this wideband transmission therefore may be corrupted by the narrowband transmission. This may be particularly the case since the narrowband interference may be relatively strong and because the wideband transmission may use an aggressive modulation and coding scheme to increase data rate with little margin for managing interference.

### SUMMARY

One problem with many wideband systems is that they are not designed for handling narrowband interference. This may lead to the wideband system suffering from performance issues, since it may need to rely on retransmissions of packets that were not successfully received by a receiver. Specifically, in examples where the wideband system uses LBT with exponential back-off, the lack of ability to a handle narrowband interference may be particularly severe, since an erroneous transmission typically means that the contention window is doubled.

One aspect of the present disclosure provides a method in a first wireless communication device of encoding data for transmission to a second wireless communication device using a first signal in a first frequency range having a first bandwidth. The method comprises determining a second bandwidth based on at least one interference signal within the first frequency range, wherein the second bandwidth is smaller than the first bandwidth, and selecting a code rate based on the second bandwidth such that the data is recoverable from a portion of the first signal having a bandwidth equal to or less than the first bandwidth minus the second bandwidth. The method also comprises encoding the data using the code rate to produce encoded data bits.

A further aspect of the present disclosure provides a method in a second wireless communication device of decoding data. The method comprises receiving, from a first wireless communication device, a first signal in the first frequency range and having a first bandwidth, the data including encoded data bits, and determining at least one second frequency range based on at least one interference signal within the first frequency range, wherein the interference signal has a second bandwidth that is smaller than the first bandwidth. The method also comprises decoding the encoded data bits based on the at least one second frequency range.

An additional aspect of the present disclosure provides apparatus in a first wireless communication device for encoding data for transmission to a second wireless communication device using a first signal in a first frequency range having a first bandwidth.

The apparatus comprises a processor and a memory. The memory contains instructions executable by the processor such that the apparatus is operable to determine a second bandwidth based on at least one interference signal within the first frequency range, wherein the second bandwidth is smaller than the first bandwidth, select a code rate based on the second bandwidth such that the data is recoverable from a portion of the first signal having a bandwidth equal to or less than the first bandwidth minus the second bandwidth, and encode the data using the code rate to produce encoded data bits.

Another aspect of the present disclosure provides apparatus in a second wireless communication device for decoding data. The apparatus comprises a processor and a memory. The memory contains instructions executable by the processor such that the apparatus is operable to receive, from a first wireless communication device, a first signal in the first frequency range and having a first bandwidth, the data including encoded data bits, determine at least one second frequency range based on at least one interference signal within the first frequency range, wherein the at least one interference signal has a second bandwidth that is smaller than the first bandwidth, and decode the encoded data bits based on the at least one second frequency range.

A further aspect of the present disclosure provides apparatus in a first wireless communication device for encoding data for transmission to a second wireless communication device using a first signal in a first frequency range having a first bandwidth. The apparatus is configured to determine a second bandwidth based on at least one interference signal within the first frequency range, wherein the second bandwidth is smaller than the first bandwidth, select a code rate based on the second bandwidth such that the data is recoverable from a portion of the first signal having a bandwidth equal to or less than the first bandwidth minus the second bandwidth, and encode the data using the code rate to produce encoded data bits.

A still further aspect of the present disclosure provides apparatus in a second wireless communication device for decoding data. The apparatus is configured to receive, from a first wireless communication device, a first signal in the first frequency range and having a first bandwidth, the data including encoded data bits, determine at least one second frequency range based on at least one interference signal within the first frequency range, wherein the at least one interference signal has a second bandwidth that is smaller than the first bandwidth, and decode the encoded data bits based on the at least one second frequency range.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an illustration of how a narrowband signal overlaps with a wideband signal;

FIG. 2 is a flow chart of an example of a method in a first wireless communication device of encoding data for transmission;

FIG. 3 shows a graph of an example of signal to noise ratio (SNR) as a function of frequency at an example receiver;

FIG. 4 is a flow chart of an example of a method in a second wireless communication device of decoding data;

FIG. 5 is a schematic of an example of an apparatus in a first wireless communication device for encoding data; and

FIG. 6 is a schematic of an example of an apparatus in a second wireless communication device for decoding data.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments of this disclosure may provide methods of encoding data for transmission, whereby the data is encoded using a code rate that is based on a bandwidth of an interference signal. The code rate is selected such that the data is recoverable from a portion of the first signal having a bandwidth equal to or less than the first bandwidth minus the second bandwidth. Thus, for example, if a portion of the channel or spectrum is affected by the interference signal in a manner that any data or information that is transmitted in that portion is unreliable or completely unrecoverable, the data may still be correctly received and decoded at the receiver to recover all of the data. This may also be the case for example even if the precise frequency of the interfering signal is not known or changes during transmission of the encoded data, for example if the interfering signal uses frequency hopping (FH).

Certain examples of this disclosure are described in the context of a wideband signal, which is a Wi-Fi signal, and a narrowband interfering signal, which is a Bluetooth signal. However, these are merely non-limiting examples, and the examples described can be applied to any other scenario where a signal to be transmitted has a larger bandwidth than an interfering signal. The general principle in some examples is to ensure that the part of the signal that is not interfered carries enough information to allow for successful decoding.

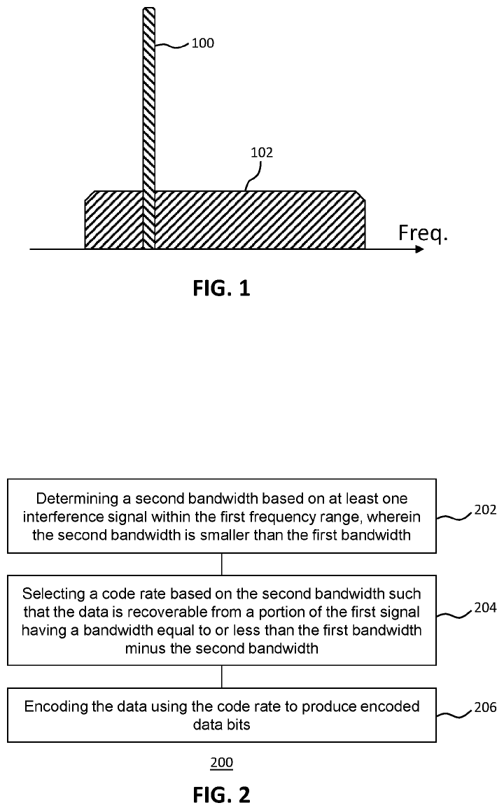

FIG. 1 shows an illustration of how a narrowband signal 100 (e.g. a Bluetooth signal) overlaps with a wideband signal 102 (e.g. a Wi-Fi signal) and thus is an interference signal from the point of view of the wideband signal 102. For example, the wideband signal 102 has a first frequency range (and therefore a first bandwidth), and the narrowband signal 100 is within the first frequency range and has a bandwidth that is smaller than the first bandwidth.

In some examples, the narrowband or Bluetooth signal may not be present at the start of the transmission of the wideband or Wi-Fi signal. For example, the transmitter may use listen before talk (LBT) before making a Wi-Fi transmission, i.e. it senses the channel before initiating a transmission. The LBT procedure may indicate that there is no signal present in the first frequency range that the transmitter wishes to use for the Wi-Fi transmission. Bluetooth, on the other hand, uses frequency hopping (FH) and will only cause interference to a very limited part of the frequency band, as shown in FIG. 1 for example. Bluetooth may also use adaptive frequency hopping (AFH) in some examples, where the transmitter of a Bluetooth signal avoids using certain frequencies that have been found to be severely interfered e.g. by other systems such as Wi-Fi. AFH is often an effective approach to ensure good coexistence with Wi-Fi by simply detecting and avoiding the Wi-Fi channel. However, when Wi-Fi is using large bandwidths, e.g. 80 MHz, this means that the Bluetooth system may find all channels to be interfered and thus it is not possible to apply AFH to avoid the Wi-Fi channel.

Although this implies that there will be interference between narrowband and wideband systems such as Bluetooth and Wi-Fi so that both will be impacted in a negative way, the fact that they are using very different bandwidths may still allow for relatively good coexistence. Referring to FIG. 1 for example, since the bandwidth of the Bluetooth signal is much smaller than the bandwidth of the Wi-Fi signal, the Bluetooth receiver may be able to suppress most of the Wi-Fi interference. If for example the Wi-Fi signal bandwidth is 80 MHz and the Bluetooth signal bandwidth is 1 MHz, only 1/80 th of the Wi-Fi signal will cause problem for the Bluetooth receiver. Effectively, considering the signal-to-interference ratio (SIR), the interference is reduced by roughly 19 dB ( 1/80) when considering only the bandwidth of the Bluetooth signal. Thus, if both signals are received with the same power, the SIR at the input to the Bluetooth demodulator will be 19 dB, which is typically more than sufficient for correct reception of a packet.

Considering the opposite scenario, i.e. how the wideband or Wi-Fi signal is affected by the narrowband or Bluetooth transmission, it can be seen in the example in FIG. 1 that the narrowband signal 100 will affect only a limited part of the Wi-Fi signal 102. This means that a wideband system may be able to reduce the impact of interference from a narrowband signal. Example embodiments of this disclosure may provide methods and apparatus for reducing the impact of such interference.

FIG. 2 is a flow chart of an example of a method 200 in a first wireless communication device of encoding data for transmission to a second wireless communication device using a first signal in a first frequency range having a first bandwidth. The first signal may be for example a wideband or Wi-Fi signal such as the signal 102 shown in FIG. 1. The method 200 comprises, in step 202, determining a second bandwidth based on at least one interference signal within the first frequency range, wherein the second bandwidth is smaller than the first bandwidth. The at least one interference signal may be for example at least one narrowband or Bluetooth signal, such as for example the signal 100 shown in FIG. 1. In some examples, the bandwidth of the interfering signal(s) may be known or assumed to be a certain bandwidth, such as for example the bandwidth of a known signal type or Bluetooth signal. The second bandwidth may be determined based on this bandwidth. Alternatively, for example, the second bandwidth may be based on measurements at the first wireless communication device or based on information provided by the second wireless communication device, as described further below. In some examples the first frequency range may be within unlicensed spectrum, such as for example the 2.4 GHz industrial, scientific and medical (ISM) band or the 5 GHz band.

Step 204 of the method 200 comprises selecting a code rate based on the second bandwidth such that the data is recoverable from a portion of the first signal having a bandwidth equal to or less than the first bandwidth minus the second bandwidth. Step 206 comprises encoding the data using the code rate to produce encoded data bits. The encoded data bits may then be transmitted to the second wireless communication device, for example as a wideband or Wi-Fi signal.

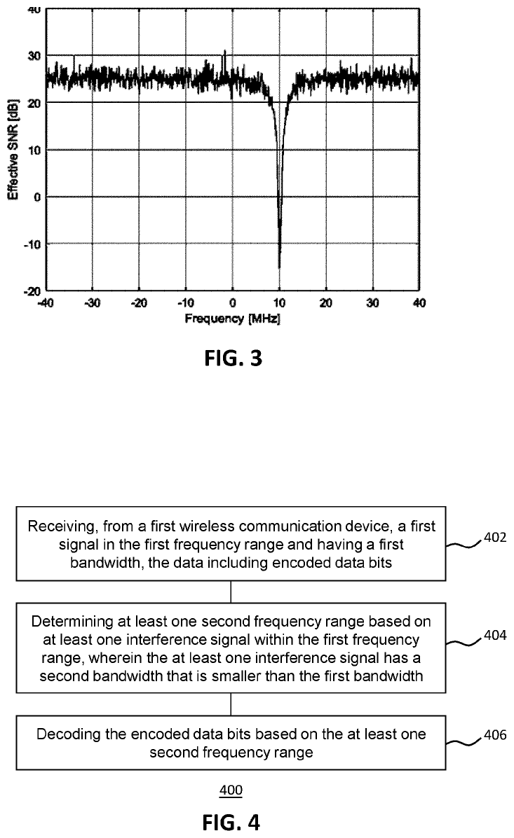

The second bandwidth may be determined for example as being the bandwidth of the at least one interfering signal (e.g. the total bandwidth if there is more than one interfering signal). Alternatively, for example, the second bandwidth may be determined as being a bandwidth that is affected or impacted by the at least one interfering signal. FIG. 3 shows a graph of an example of signal to noise ratio (SNR) as a function of frequency at an example receiver (e.g. the second wireless communication device) of the transmitted data, which may be transmitted as a Wi-Fi signal, when interfered by a Bluetooth signal. This is illustrated in FIG. 3 where the data is transmitted using an 80 MHz wideband signal and is interfered by a 1 MHz wide Bluetooth signal at 10 MHz above the center frequency of wideband signal. It can be seen in FIG. 3 that the impact of the 1 MHz interference signal is limited to a small part of the 80 MHz signal as expected. It can also be seen that, in this example, significantly more than 1 MHz of the wideband signal is impacted to a varying degree.

In the example shown in FIG. 3, the SNR is 25 dB and the SIR is 10 dB. The interference is only impacting a relatively small part of the total bandwidth by noting that the effective signal to interference plus noise ratio (SINR) is the same as the SNR (25 dB) and thus there is no noticeable impact of the interference. Furthermore, the SIR of 10 dB refers to the average SIR over the 80 MHz bandwidth. At the location of the interferer, the SIR is less than −10 dB, and thus here the impact of the noise can be ignored. To be able to handle the narrowband interference two things are considered, namely the impact of the noise and the impact of the interference. If only noise were to be considered, a suitable modulation and coding scheme (MCS) would be selected based on the (average) SNR over the 80 MHz channel. This would mean that the MCS would be selected without any specific consideration of the code rate. The SNR will essentially determine the maximum data rate that can be supported, and often this is achieved with a code with relatively high rate (e.g. ¾, ⅘ or even ⅚). In some examples, the second bandwidth that is affected or impacted by the interfering signal may be determined based on the SIR or SINR at the receiver of the signal used to transmit the data, e.g. the wideband or Wi-Fi signal. For example, the bandwidth that is affected or impacted may be the parts of the spectrum that are below a threshold SIR or SINR, or are below the overall SIR, SNR or SINR by a threshold amount.

In particular examples, since Wi-Fi, like many wideband systems, is based on orthogonal frequency division multiplexing (OFDM), there will be leakage of signals into adjacent frequencies as shown by a fast Fourier transform (FFT). This leakage can be estimated, and in particular it can be shown that the amount of leakage will depend on the strength of the interfering signal. Therefore, the code rate selected in step 204 of the method 200 may in some examples be based on the estimated SIR (or SNR, or SINR) at the receiver, such that a lower rate potentially may be selected in case the SIR is expected to be low. Since the FFT effectively indicates the power of a signal at the different frequency bins, the power that will be found at the different bins can be expected to follow the same shape as the power spectrum density of the transmitted signal. As the FFT is linear, it also follows that the interference power at the output of the FFT is proportional to the power of the interference, and consequently that if the SIR over the full bandwidth is known, the SIR for the different parts of the bandwidth can be determined. Following this reasoning, as an example, if one would consider a frequency bin of the FFT as being impacted or affected by interference if the SIR is below 10 dB and not so impacted or affected otherwise, the number of bins that are impacted or affected (and hence the second bandwidth for example) can be estimated based on the SIR of the signal over the full bandwidth.

In some examples, as suggested above, determining the second bandwidth based on the at least one interference signal comprises receiving an indication of the second bandwidth from the second wireless communication device. For example, the indication of the second bandwidth comprises an indication of a signal to noise ratio (SNR), signal to interference ratio (SIR) or signal to interference plus noise ratio (SINR) in at least a portion of the first frequency range of a signal received at the second wireless communication device. The indication may for example indicate information that takes a form similar to that shown in FIG. 3, e.g. the SNR/SIR/SINR across the first frequency range. Thus, for example, determining the second bandwidth based on the at least one interference signal may comprise determining portions of the first frequency range where the SNR, SIR or SINR is lower than a threshold.

In some examples, the first signal comprises a plurality of subcarriers, such as for example an orthogonal frequency division multiplexing (OFDM) signal. In such examples, the method 200 may comprise determining a number of one or more first subcarriers of the plurality of subcarriers, wherein the one or more first subcarriers have a total bandwidth that is at least as large as the second bandwidth. The code rate may then be selected such that the data is recoverable from the number of the plurality of subcarriers minus the number of the one or more first subcarriers. Thus, for example, the data may be recoverable from unaffected subcarriers (or subcarriers that are affected or impacted by an insignificant amount by the one or more interference signal).

In some examples, once the code rate has been selected, the method 200 may comprise selecting a modulation and coding scheme based at least on the code rate. For example, where a lower code rate is selected, a modulation and coding scheme may be selected to compensate for a lower code rate so as to meet a minimum date rate. Transmitting the encoded data bits may comprise transmitting the encoded data bits according to the selected modulation and coding scheme.

Determining the second bandwidth based on at least one interference signal within the first frequency range may in some examples comprise determining the second bandwidth based on a probability of the at least one interference signal being present. For example, the first wireless communication device (or any other device, such as the second wireless communication device) may monitor the communication channel to determine how often an interfering signal appears, or may monitor for example the number or frequency of LBT failures (e.g. the number or frequency of occasions where the LBT procedure indicates that the channel is occupied) or transmission failures (e.g. negative acknowledgements, NACKs, or unacknowledged transmissions). The probability may be for example the probability of the at least one interference signal being present within a duration for transmitting the data using the first signal. In some examples, the first wireless communication device may measure the probability of the interference signal being present. Alternatively, for example, an indication of the probability of the interference signal being present may be received from the second wireless communication device.

In some examples, determining the second bandwidth based on the probability of the interference signal being present comprises determining that the probability is within one of a plurality of probability ranges, and selecting a predetermined second bandwidth associated with the one of the plurality of probability ranges. For example, a larger second bandwidth may be selected for a higher probability in this manner (which may also suggest a higher probability of two or more interfering signals being present during transmission of the data). In one example, the probability ranges include a first probability range from zero to a first probability, and the second bandwidth associated with the first probability range is zero bandwidth. In this case, the first probability may for example be considered as a threshold probability, below which the second bandwidth is selected to be zero (effectively such that the code rate is selected to assume that no interfering signal will be present for the transmission of the data).

The interference signal may be for example within a second frequency range within the first frequency range. Thus, selecting the code rate based on the second bandwidth such that the data is recoverable from a portion of the first signal having a bandwidth equal to or less than the first bandwidth minus the second bandwidth may in some examples comprise selecting a code rate such that the data is recoverable from a portion of the first signal outside of the second frequency range. The second frequency range may be measured by the first wireless communication device, or an indication of the second frequency range may be received from the second wireless communication device.

As noted above, there may in some examples be more than one narrowband interferer present (or their presence may be assumed). The total bandwidth of the interfering signals may therefore be used for selecting a code rate. As an example, if one interferer is expected to impact 2 MHz and it is desirable to have a code rate that can handle as many as three concurrent interfering signals, a bandwidth of 3×2 MHz=6 MHz may be used when determining the second bandwidth or selecting the code rate.

In a particular example, suppose that as much as 20% of the spectrum can be assumed to be impacted by at least one interference signal. In this case, the code rate may be selected to be ⅔, ¾ or ⅘. If a higher rate code is selected, this may cause the number of bits in the remaining 80% of the spectrum to be insufficient to recover the data in some examples.

FIG. 4 is a flow chart of an example of a method 400 in a second wireless communication device of decoding data. In some examples, the data may be encoded according to some of the examples of the method 200 described above. The method 400 comprises, in step 402, receiving, from a first wireless communication device, a first signal in the first frequency range and having a first bandwidth, the data including encoded data bits. Step 404 comprises determining at least one second frequency range based on at least one interference signal within the first frequency range, wherein the at least one interference signal has a second bandwidth that is smaller than the first bandwidth. The second bandwidth may be the bandwidth of a particular signal type, e.g. a Bluetooth signal, or alternatively may be the bandwidth that is impacted or affected by the signal.

Step 406 of the method 400 comprises decoding the encoded data bits based on the at least one second frequency range. That is, for example, the decoding may take into account the second frequency range, for example by treating encoded data bits received within the second frequency range in a certain manner as it is possible or likely that these have been impacted or affected by the at least one interference signal. For example, decoding the encoded data bits based on the at least one second frequency range may in some examples comprise decoding the encoded data bits using a portion of the first signal outside of the at least one second frequency range.

For example, the decoding may include determining a log likelihood ratio (LLR) for each of a plurality of bits in the first signal, wherein the bits correspond to the encoded data bits (e.g. the encoded data bits are labels of the received signal in a symbol constellation). The method 400 may for example comprise reducing or zeroing the LLRs of bits that are received within the second frequency range. For example, where the first signal comprises a plurality of subcarriers, LLRs of bits received on subcarriers within the at least one second frequency range may be reduced or set to zero. Thus, the contribution to the decoded data that these bits make to the decoding process or to the decoded data may be reduced or eliminated.

In some examples, determining the at least one second frequency range based on the at least one interference signal comprises determining a signal to noise ratio (SNR), signal to interference ratio (SIR) or signal to interference plus noise ratio (SINR) of the first signal or another signal received at the second wireless communication device in at least a portion of the first frequency range. For example, determining the at least one second frequency range of the at least one interference signal comprises determining portions of the first frequency range where the SNR, SIR or SINR is lower than a threshold. The SNR, SIR or SINR may take a form similar to that shown in FIG. 3 in some examples. This may be measured by the second wireless communication device in some examples.

Determining the at least one second frequency range based on the at least one interference signal may comprise for example detecting at least one interference signal in the at least one second frequency range. For example, the second frequency range may be measured (e.g. using the SNR/SIR/SINR illustrated in FIG. 3). In some examples, an indication of the second frequency range (or at least its bandwidth) may be sent to the first wireless communication device, which may for example use this information to select a code rate, for example using the method 200 described above. Alternatively, for example, an indication of the second frequency range may be received from the first wireless communication device, e.g. after measuring or detecting by the first wireless communication device.

Detection of the narrowband interference can in some examples be viewed as a relatively simple problem in that it only needs to be detected when the interferer is relatively strong, since this is when it has a major impact on the performance of the communication system. If the detection algorithm fails to detect a weak interfering signal, this would probably only have a marginal impact on the link performance.

In particular examples, the first step in processing by the receiver (e.g. the second wireless communication device) is to determine if there is narrowband interference that needs to be considered. The detection of the narrowband interference may be done in various ways, but one approach is to use the fact that the receiver continuously tracks the channel to equalize the channel to perform coherent reception. When doing this channel estimation, an interferer that suddenly appears will cause an abrupt change which can be detected. This change may be detected for example in the time direction, i.e., the channel estimate for some of the sub-carriers in the OFDM signal suddenly becoming very noisy. The change may also be detected in the frequency direction, by noting that in a single OFDM symbol, some of the estimates corresponding to one or more of the sub-carriers are more noisy than the rest of the channel estimates. The presence may be detected for example when the channel estimate is determined to change by more than a threshold value. This approach may be applicable irrespective of the implementation of the equalizer, which may in some examples be based on zero-forcing or minimum mean square error (MMSE), which are well-known equalizer structures.

Once the interferer is detected at the receiver, or alternatively for example the receiver receives an indication of the frequencies impacted or affected by the receiver, it identifies which of the encoded bits are impacted. After having equalized the signal, the reliability of the coded bits is determined, e.g. using log-likelihood ratios (LLRs) for the encoded bits. These LLRs may then be used by the error correcting decoder when attempting to decode the received information.

If a signal is interfered by narrowband interference and the signal is processed without taking any counter measures, the LLRs corresponding to the bits that are interfered may be severely corrupted and result in erroneous decoding. One simple way to improve the performance is to simply set the corresponding LLRs to zero, as suggested above, and effectively view the corresponding bits as erased. For this approach to be successful, in some examples, the number of LLRs that are impacted and therefore set to zero must not be too many. Here, too many should be considered in relation to the rate of the code. The lower the code rate, the larger the fraction of the LLRs that can be set to zero and the data still be recoverable. This is in some examples the reason why the code rate was selected to be sufficiently low by the transmitter (e.g. the first wireless communication device).

Performance may be improved in some examples as follows. Firstly, as noted in FIG. 3, although several sub-carriers typically are impacted by the interference, they may not impacted to the same degree. As a result, some of the bits will be severely impacted so that they essentially carry no information, whereas other bits are impacted by only a small amount and may still carry some information that is useful in the decoding. Secondly, the impact of the interfering signal will depend on the SIR (or SNR/SINR) so that a larger impact can be expected when the SIR is low. Therefore, to further improve performance, an approach is disclosed where the impact of the interference on the individual sub-carriers is determined and the LLRs for the corresponding bits may be calculated accordingly. In one example, the effective signal-to-interference-plus-noise ratio (SINR) may be determined to calculate the LLR. Specifically, if the SIR over the full bandwidth is estimated, this can be used to determine the SIR for the individual sub-carriers as the shape of the interfering signal may be known.

In some examples, the SINR for different sub-carriers may be determined by first determining the SIR (e.g. using the total estimated power of the signal and the interferer), and then making use of the measured or estimated spectrum of the interferer such that the effective SINR for the different sub-carriers can be estimated without considering the individual sub-carriers. In an alternative implementation, where impacted LLRs may be set to zero, the SIR may be used to determine how many of the sub-carriers should be considered impacted by the interferer. Specifically, a larger number of sub-carriers is considered to be impacted when the SIR is low. Thus a larger number of LLRs will be set to zero in case the SIR is determined to be low.

The selection of proper modulation and coding parameters is done in some examples by the transmitter as described above. However, the transmitter may need input from the receiver regarding the interference situation at the receiver, particularly where the interference situation is significantly different between the transmitter and the receiver. Thus, the receiver may signal relevant information to the transmitter. Examples of such information including indications of information have been described above. Such information may be semi-static, i.e. the information is sent infrequently and may provide statistical information about the interference. Example of such statistical information include the probability that the interference is or will be present as discussed above, statistics for the expected power of the interference, and/or statistics related to the total bandwidth of the interference or the affected or impacted bandwidth. For example, it may be that there is a 50% probability that one 1 MHz wide interferer is present, 25% probability that in total 2 MHz is interfered, and 5% that 3 MHz and more is interfered. The probability for no interferer being present is in this case 20%. These may be examples of the probability ranges described above.

Alternatively, the information sent from the intended receiver to the transmitter may be applicable for only the subsequent packet. This may be the case for example if the transmitter sends a request-to-send (RTS) packet to the intended receiver and the receiver replies with a clear-to-send (CTS) packet. Assuming that the interference situation at the receiver is such that a CTS can still be sent, the CTS packet may then contain information about the current interference situation. As an example, a narrowband interferer may be present making a small part of the channel severely interfered, but its total energy may not be so large that it prevents the CTS packet being sent.

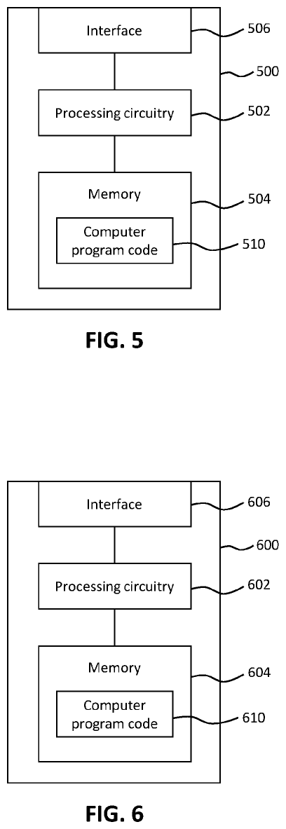

FIG. 5 is a schematic of an example of an apparatus 500 in a first wireless communication device for encoding data for transmission to a second wireless communication device using a first signal in a first frequency range having a first bandwidth. The apparatus 500 comprises processing circuitry 502 (e.g., one or more processors) and a memory 504 in communication with the processing circuitry 502. The memory 504 contains instructions, such as computer program code 510, executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable/configured to determine a second bandwidth based on at least one interference signal within the first frequency range, wherein the second bandwidth is smaller than the first bandwidth, select a code rate based on the second bandwidth such that the data is recoverable from a portion of the first signal having a bandwidth equal to or less than the first bandwidth minus the second bandwidth, and encode the data using the code rate to produce encoded data bits. In some examples, the apparatus 500 is operable/configured to carry out the method 200 described above with reference to FIG. 2.

FIG. 6 is a schematic of an example of an apparatus 600 in a second wireless communication device for decoding data. The apparatus 600 comprises processing circuitry 602 (e.g., one or more processors) and a memory 604 in communication with the processing circuitry 602. The memory 604 contains instructions, such as computer program code 610, executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

In one embodiment, the memory 604 contains instructions executable by the processing circuitry 602 such that the apparatus 600 is operable/configured to receive, from a first wireless communication device, a first signal in the first frequency range and having a first bandwidth, the data including encoded data bits, determine at least one second frequency range based on at least one interference signal within the first frequency range, wherein the at least one interference signal has a second bandwidth that is smaller than the first bandwidth, and decode the encoded data bits based on the at least one second frequency range. In some examples, the apparatus 600 is operable/configured to carry out the method 400 described above with reference to FIG. 4.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first wireless communication device of encoding data for transmission to a second wireless communication device using a first signal in a first frequency range having a first bandwidth, the method comprising:
determining a second bandwidth based on at least one interference signal within the first frequency range, the second bandwidth being smaller than the first bandwidth;
selecting a code rate based on the second bandwidth such that the data is recoverable from a portion of the first signal having a bandwidth equal to or less than the first bandwidth minus the second bandwidth; and
encoding the data using the code rate to produce encoded data bits.

2. The method of claim 1, wherein determining the second bandwidth based on the at least one interference signal comprises receiving an indication of the second bandwidth from the second wireless communication device.

3. The method of claim 2, wherein the indication of the second bandwidth comprises an indication of a signal to noise ratio (SNR), signal to interference ratio (SIR) or signal to interference plus noise ratio (SINR) in at least a portion of the first frequency range of a signal received at the second wireless communication device.

4. The method of claim 3, wherein determining the second bandwidth based on the at least one interference signal comprises determining portions of the first frequency range where the SNR, SIR or SINR is lower than a threshold.

5. (canceled)

6. The method of claim 1, wherein determining the second bandwidth based on the at least one interference signal comprises measuring the second bandwidth or detecting the at least one interference signal.

7. The method of claim 1, wherein the first signal comprises a plurality of subcarriers, and the method comprises:
determining a number of one or more first subcarriers of the plurality of subcarriers, wherein the one or more first subcarriers have a total bandwidth that is at least as large as the second bandwidth,
and wherein the code rate is selected such that the data is recoverable from the number of the plurality of subcarriers minus the number of the one or more first subcarriers.

8. (canceled)

9. The method of claim 1, wherein determining the second bandwidth based on at least one interference signal within the first frequency range comprises determining the second bandwidth based on a probability of the at least one interference signal being present.

10. The method of claim 9, wherein the probability of the interference signal being present comprises the probability of the at least one interference signal being present within a duration for transmitting the data using the first signal.

11. (canceled)

12. (canceled)

13. (canceled)

14. The method of claim 1, wherein the interference signal is within a second frequency range within the first frequency range, and selecting a code rate based on the second bandwidth such that the data is recoverable from a portion of the first signal having a bandwidth equal to or less than the first bandwidth minus the second bandwidth comprises selecting a code rate such that the data is recoverable from a portion of the first signal outside of the second frequency range.

15. (canceled)

16. The method of claim 1, wherein the first signal comprises an orthogonal frequency division multiplexing (OFDM) signal, and/or the interference signal comprises a frequency hopping signal.

17. The method of claim 1, wherein the first frequency range is in unlicensed spectrum.

18. The method of claim 1, comprising transmitting the encoded data bits to the second wireless communication device using the first signal having the first bandwidth in the first frequency range.

19. The method of claim 1, wherein determining a second bandwidth based on at least one interference signal within the first frequency range comprises determining a bandwidth of the at least one interference signal or determining a bandwidth impacted or affected by the at least one interference signal.

20. A method in a second wireless communication device of decoding data, the method comprising:
receiving, from a first wireless communication device, a first signal in the first frequency range and having a first bandwidth, the data including encoded data bits;
determining at least one second frequency range based on at least one interference signal within the first frequency range, the at least one interference signal having a second bandwidth that is smaller than the first bandwidth; and
decoding the encoded data bits based on the at least one second frequency range.

21. The method of claim 20, wherein decoding the encoded data bits based on the at least one second frequency range comprises decoding the encoded data bits using a portion of the first signal outside of the at least one second frequency range.

22. The method of claim 20, wherein determining the at least one second frequency range based on the at least one interference signal comprises determining a signal to noise ratio (SNR), signal to interference ratio (SIR) or signal to interference plus noise ratio (SINR) of the first signal or another signal received at the second wireless communication device in at least a portion of the first frequency range.

23. The method of claim 22, wherein determining the at least one second frequency range of the at least one interference signal comprises determining portions of the first frequency range where the SNR, SIR or SINR is lower than a threshold.

24. The method of claim 20, wherein determining the at least one second frequency range based on the at least one interference signal comprises detecting at least one interference signal in the at least one second frequency range.

25. The method of claim 20, further comprising determining a log likelihood ratio (LLR) for each of a plurality of symbols or bits in the first signal, wherein the symbols correspond to the encoded data bits.

26. The method of claim 25, wherein the first signal comprises a plurality of subcarriers, and the method comprises reducing or zeroing LLRs of symbols or bits received on subcarriers within the at least one second frequency range.

27. The method of claim 20, further comprising determining a probability of the at least one interference being present within the first frequency range, and sending an indication of the probability to the first wireless communication device.

28. The method of claim 27, wherein the probability of the interference signal being present comprises the probability of the at least one interference signal being present within a duration for transmitting the data using the first signal.

29.-32. (canceled)

33. The method of claim 20, further comprising receiving an indication of the second frequency range from the first wireless communication device.

34. (canceled)

35. (canceled)

36. The method of claim 20, wherein determining the at least one second frequency range based on the at least one interference signal within the first frequency range comprises determining a bandwidth of the at least one interference signal or determining a bandwidth impacted or affected by the at least one interference signal.

37.-39. (canceled)

40. An apparatus in a first wireless communication device for encoding data for transmission to a second wireless communication device using a first signal in a first frequency range having a first bandwidth, the apparatus comprising a processor and a memory, the memory containing instructions executable by the processor such that the apparatus is operable to:
determine a second bandwidth based on at least one interference signal within the first frequency range, the second bandwidth being smaller than the first bandwidth;
select a code rate based on the second bandwidth such that the data is recoverable from a portion of the first signal having a bandwidth equal to or less than the first bandwidth minus the second bandwidth; and
encode the data using the code rate to produce encoded data bits.

41. (canceled)

42. An apparatus in a second wireless communication device for decoding data, the apparatus comprising a processor and a memory, the memory containing instructions executable by the processor such that the apparatus is operable to:
receive, from a first wireless communication device, a first signal in the first frequency range and having a first bandwidth, the data including encoded data bits;
determine at least one second frequency range based on at least one interference signal within the first frequency range, the at least one interference signal having a second bandwidth that is smaller than the first bandwidth; and
decode the encoded data bits based on the at least one second frequency range.

43.-47. (canceled)
